(19) United States
(12) Patent Application Publication
(10) Pub. No.: US 2019/0238536 A1
(43) Pub. Date: Aug. 1, 2019

(54) TECHNIQUES FOR RESUMING A SECURE COMMUNICATION SESSION

(71) Applicant: QUALCOMM Incorporated, San Diego, CA (US)

(72) Inventors: Rajashekar CHILLA, San Diego, CA (US); Abhi Umeshkumar SHAH, San Diego, CA (US); Niyati DESHPANDE, San Diego, CA (US); Udaykant PANDEY, San Diego, CA (US); Lakshmi Bhavani GARIMELLA SRIVENKATA, San Diego, CA (US)

(21) Appl. No.: 15/880,868

(22) Filed: Jan. 26, 2018

(51) Int. Cl. H04L 29/06; H04L 9/32

(52) U.S. Cl. CPC H04L 63/0869; H04L 9/3263; H04L 63/166

(57) ABSTRACT

Techniques for managing data communications are provided. These techniques includes a method that includes establishing, by a client device, a secure communication session with a server including performing mutual authentication and determining security credentials, and sending a session resumption request message to the server, after a period of time has elapsed since the secure communication session has been established, to resume the secure communication session between the client device and the server without repeating at least a portion of the mutual authentication between the client device and the server, the session resumption request message comprising a session identifier associated with the secure communication session and a message identifier.

### BACKGROUND

The Internet of Things (“IoT”) provides for the internetworking of various types of physical devices, such as lighting components, thermostats, heating or cooling components, switches, sensors, locks, industrial equipment, medical devices, and/or other access control devices, and/or other wirelessly-enabled devices. Various IoT protocols are being developed to handle the varying needs and functions of the myriad of IoT devices that are being developed, including but not limited to the Enhanced Machine-Type Communication (eMTC), the Narrowband Internet of Things (NB-IoT) protocls, and the Lightweight Machine-to-Machine (LwM2M) protocols. These are merely examples of a few of the IoT protocols that have been or currently are under development.

Power consumption is also an important aspect of IoT design. IoT devices may be deployed in remote locations and/or in harsh operating environments and may depend on limited power supplies to power the devices. Accordingly, the IoT devices may be configured to enter into a power saving mode (PSM) periodically or when certain conditions are met in order to conserve power at the device.

### SUMMARY

An example method for managing data communications according to the disclosure includes establishing, by a client device, a secure communication session with a server including performing mutual authentication and determining security credentials, and sending a session resumption request message to the server, after a period of time has elapsed since the secure communication session has been established, to resume the secure communication session between the client device and the server without repeating at least a portion of the mutual authentication between the client device and the server, the session resumption request message comprising a session identifier associated with the secure communication session and a message identifier.

Implementations of such a method can include one or more of the following features. Sending the session resumption request message includes encrypting at least a portion of the session resumption request message using a cryptographic key associated with the security credentials of the client device. The message identifier is included in the encrypted portion of the session resumption request message, and the session identifier is included in an unencrypted portion of the session resumption request message. Receiving a session resumption response message from the server indicating whether the server has accepted the session resumption request message from the server. Authenticating the session resumption response message from the server by decrypting an encrypted portion of the session resumption response message from the server using cryptographic keys associated with the security credentials for the server to generate decrypted content, extracting the message identifier from the decrypted content, and determining whether the message identifier is an expected value. Sending encrypted data to the server responsive to authenticating the session resumption response message. The secure communication session comprises a Datagram Transport Layer Security (DTLS) session. The client device comprises a Lightweight Machine to Machine (“LwM2M”) client and the server comprises a LwM2M server.

An example device according to the disclosure includes a memory and a processor coupled to the memory. The processor is configured to establish a secure communication session with a server including performing mutual authentication and determining security credentials, and send a session resumption request message to the server, after a period of time has elapsed since the secure communication session has been established, to resume the secure communication session between the device and the server without repeating at least a portion of the mutual authentication between the device and the server, the session resumption request message comprising a session identifier associated with the secure communication session and a message identifier.

Implementations of such a device can include one or more of the following features. The processor being configured to send the session resumption request message is further configured to encrypt at least a portion of the session resumption request message using a cryptographic key associated with the security credentials of the device. The message identifier is included in the encrypted portion of the session resumption request message, and wherein the session identifier is included in an unencrypted portion of the session resumption request message. The processor is configured receive a session resumption response message from the server indicating whether the server has accepted the session resumption request message from the server. The processor is configured to authenticate the session resumption response message from the server, the processor being further configured to decrypt an encrypted portion of the session resumption response message from the server using cryptographic keys associated with the security credentials for the server to generate decrypted content, extract the message identifier from the decrypted content, and determine whether the message identifier is an expected value. The processor is configured to sending encrypted data to the server responsive to authenticating the session resumption response message. The secure communication session comprises a Datagram Transport Layer Security (DTLS) session. The device comprises a Lightweight Machine to Machine (“LwM2M”) client and the server comprises a LwM2M server.

An example device according to the disclosure includes means for establishing a secure communication session with a server including performing mutual authentication and determining security credentials, and means for sending a session resumption request message to the server, after a period of time has elapsed since the secure communication session has been established, to resume the secure communication session between the device and the server without repeating at least a portion of the mutual authentication between the device and the server, the session resumption request message comprising a session identifier associated with the secure communication session and a message identifier.

Implementations of such a device can include one or more of the following features. The means for sending the session resumption request message includes means for encrypting at least a portion of the session resumption request message using a cryptographic key associated with the security credentials of the device. The message identifier is included in the encrypted portion of the session resumption request message, and the session identifier is included in an unencrypted portion of the session resumption request message. Means for receiving a session resumption response message from the server indicating whether the server has accepted the session resumption request message from the server. Means for authenticating the session resumption response message from the server comprising means for decrypting an encrypted portion of the session resumption response message from the server using cryptographic keys associated with the security credentials for the server to generate decrypted content, means for extracting the message identifier from the decrypted content, and means for determining whether the message identifier is an expected value. Means for sending encrypted data to the server responsive to authenticating the session resumption response message. The secure communication session comprises a Datagram Transport Layer Security (DTLS) session. The device comprises a Lightweight Machine to Machine (“LwM2M”) client and the server comprises a LwM2M server.

An example non-transitory, computer-readable medium according to the disclosure has stored thereon computer-readable instructions for managing data communications. The instructions are configured to cause a computing device to establish a secure communication session with a server including performing mutual authentication and determining security credentials, and send a session resumption request message to the server, after a period of time has elapsed since the secure communication session has been established, to resume the secure communication session between the computing device and the server without repeating at least a portion of the mutual authentication between the computing device and the server, the session resumption request message comprising a session identifier associated with the secure communication session and a message identifier.

Implementations of such a non-transitory, computer-readable medium can include one or more of the following features. The instructions configured to cause the computing device to send the session resumption request message include instructions configured to cause the computing device to encrypt at least a portion of the session resumption request message using a cryptographic key associated with the security credentials of the computing device. The message identifier is included in the encrypted portion of the session resumption request message, and the session identifier is included in an unencrypted portion of the session resumption request message. Instruction configured to cause the computing device to receive a session resumption response message from the server indicating whether the server has accepted the session resumption request message from the server. Instructions configured to cause the computing device to authenticate the session resumption response message from the server, the instructions including instructions configured to cause the computing device to: decrypt an encrypted portion of the session resumption response message from the server using cryptographic keys associated with the security credentials for the server to generate decrypted content, extract the message identifier from the decrypted content, and determine whether the message identifier is an expected value. The secure communication session comprises a Datagram Transport Layer Security (DTLS) session, and the computing device comprises a Lightweight Machine to Machine (“LwM2M”) client and the server comprises a LwM2M server.

### BRIEF DESCRIPTION OF THE DRAWINGS

FIG. 1 is a functional block diagram of an example operating environment illustrating the techniques disclosed herein.

FIG. 2 is a functional block diagram of an example computer system that can be used to implement the client device and/or the server illustrated in FIG. 1.

FIG. 3 is a signal flow diagram illustrating example interactions between a client device and a server to an DTLS session in accordance with certain example implementations.

FIG. 4 is a signal flow diagram illustrating example interactions between a client device and a server to an DTLS session in accordance with certain example implementations.

FIG. 5 is a signal flow diagram illustrating example interactions between a client device and a server to an DTLS session in accordance with certain example implementations.

FIG. 6 is a signal flow diagram illustrating example interactions between a client device and a server to an DTLS session in accordance with certain example implementations.

FIG. 7 is an illustration of an example process for a client-initiated resumption of a secure communication session on a client device according to the techniques disclosed herein.

FIG. 8 is an illustration of an example process for a client-initiated resumption of a secure communication session on a server according to the techniques disclosed herein.

FIG. 9 is an illustration of an example process for a server-initiated resumption of a secure communication session on a client device according to the techniques disclosed herein.

FIG. 10 is an illustration of an example process for a server-initiated resumption of a secure communication session on a server according to the techniques disclosed herein.

FIG. 11 illustrates an example process for authenticating a session resumption request message.

FIG. 12 illustrates an example process for authenticating a session resumption response message.

### DETAILED DESCRIPTION

Technique for resuming a secure communication session between two devices are provided. The techniques disclosed herein can be used to resume the secure communication session without having reinitiate the session between the devices, which can require a significant amount of processing and network communications that can consume a significant amount of power in a power constrained device. The techniques disclosed herein can be used to resume a DTLS session that has been established between a client device and a server. Either client device or the server can attempt to resume the already established session between the devices. The techniques disclosed herein can be used to avoid having to perform the handshake between the devices prior to resuming the DTLS session, which can significantly reduce the number of messages that need to be exchanged between the client device and the server and can significantly reduce power consumption at the client device. The following example implementations illustrates these techniques. Furthermore, while the techniques disclosed herein utilize DTLS as the secure communications protocol, these techniques can be adapted for use with other secure communications protocols.

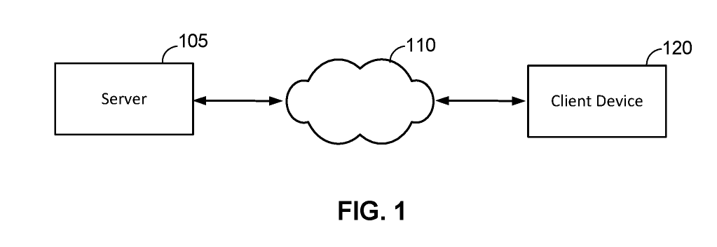

FIG. 1 is a functional block diagram of an example operating environment illustrating the techniques disclosed herein. The example operating environment includes a client device 120, a server 105, and a network 110.

The client device 120 can be a mobile wireless device, such as wearable computing device, a smartphone, a remote control for another computing device, a vehicle or a vehicle-based computing system, a tablet computer system or other computing device. The client device 120 can also comprise one or more sensors for collecting information. The client device 120 can also be a network-enabled smart appliance, smart thermostat, or other home automation device. The client device 120 can also be a medical device, which may be worn by or implanted in a patient. The client device 120 can also be a network-enabled device for infrastructure management, such for managing and controlling one or more components of manufacturing facility, for managing and controlling agricultural equipment, for energy management, for building automation, or other situations where computing device can be detected, managed, and controlled over a network. The wireless device can be an Internet of Things (IoT) or enhanced Machine Type Communication (eMTC) device where the wireless device may be used in a remote location and may have an extended life cycle in which the client device 120 may be deployed and communicate wirelessly with the server 105 without any physical intervention from an administrator or other user authorized to deploy and/or configure the client device 120. The client device 120 is not limited to the specific examples discussed above and may be another type of network-enabled device that utilizes secure communications to communicate with a server.

The network 110 can be one or more wired and/or wireless networks. The network 110 may be a combination of private and/or public networks. The network 110 may be the global system of interconnected computer networks referred to as the Internet.

The server 105 is a network-enabled computing device that can communicate with the client device 120 via the network 110. The server 105 can be configured to send data and/or commands to the client device 120 via the network 110, and the client device 120 can be configured to send data and/or commands to the server 105 via the network 110. For example, the client device 120 can comprise a sensor or other device that can be configured to collect data and can be configured to periodically send the data to the server 105. The server 105 can be configured to queue up data and/or commands to be transmitted to the client device 120 while the client device 120 is in a low power state and to send the queued up data and/or commands to the client device 120 when the client device 120 exits the low power state.

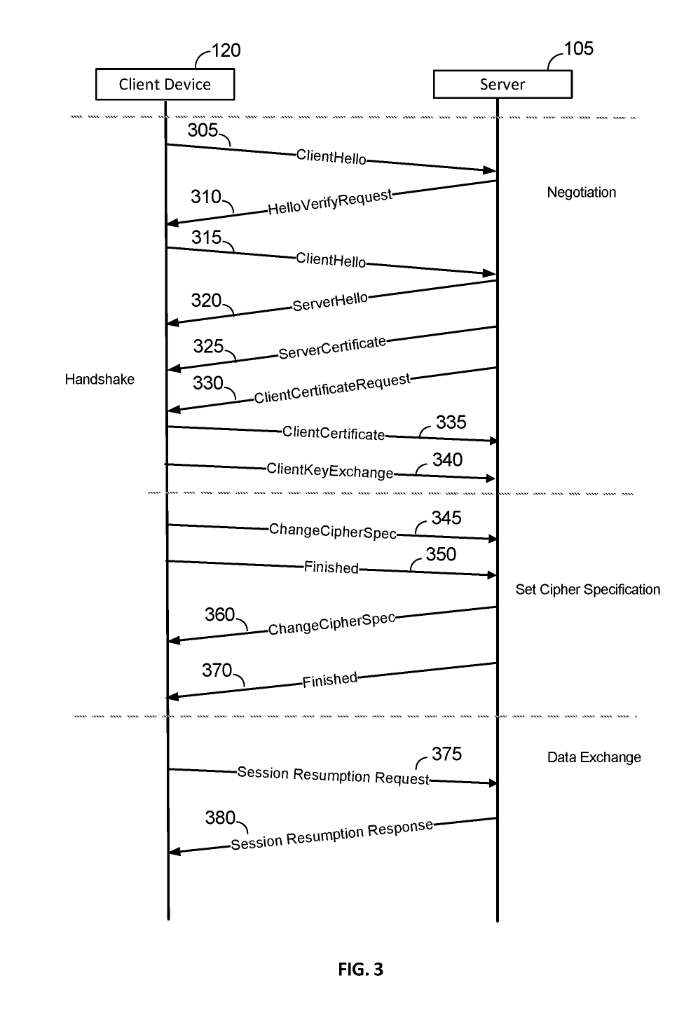

The client device 120 can be configured to implement the Open Mobile Alliance (OMA) Lightweight Machine to Machine (LwM2M) protocol for M2M or IoT device management. The client device 120 can be configured to implement a LwM2M Client and the server 105 can be configured to implement a LwM2M Server. The client device 120 and the server 105 can be configured securely communicate with one another using Datagram Transport Layer Security (DTLS) protocol, which provides security for datagram-based applications by providing mechanisms for preventing eavesdropping, tampering, and message forgery. DTLS is based on the stream-based Transport Layer Security (TLS) protocol, but provides additional mechanisms specific to datagram-based applications such as packet reordering and mechanism for dealing with loss of a datagram. The techniques disclosed herein provide processes for resuming a DTLS session that has been established between the client device 120 and the server 105. The resumption techniques disclosed herein can significantly reduce the number of packets required to be exchanged between the client device 120 and the server 105 in order to resume the DTLS session compared to conventional approaches to resumption of a DTLS session that require a handshake process to mutually authenticate the client device 120 and the server 105. The techniques disclosed herein are described in greater detail with regard to FIGS. 3-12.

The example illustrated in FIG. 1 includes a server 105 and a client device 120. Other implementation may include more than one server, more than one client device, or both. Furthermore, a client device may establish a secure communication session with more than one server, and a server may establish a secure communication session with more than one client device.

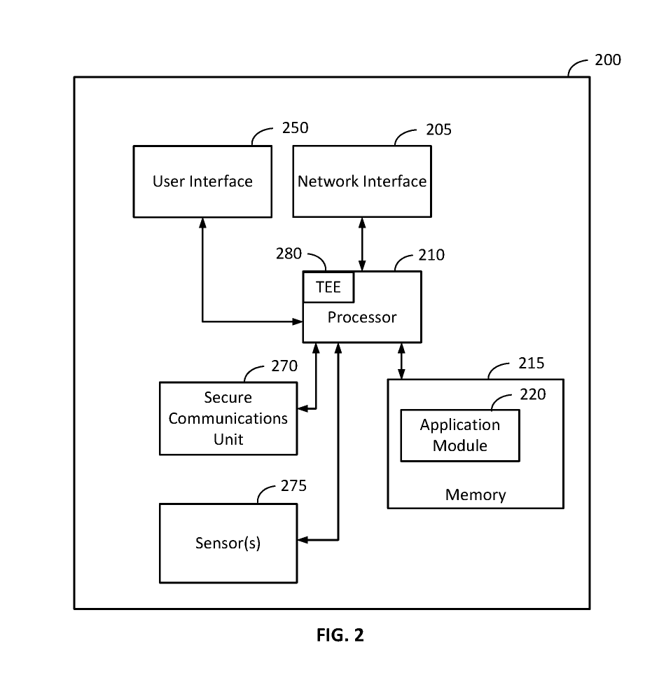

FIG. 2 is a functional block diagram of an example computing device 200 that can be used to implement various devices disclosed herein, such as the client device 120 and/or the server 105 discussed in the preceding example implementation. For the sake of simplicity, the various features/components/functions illustrated in the schematic boxes of FIG. 2 can be connected together using a common bus or are can be otherwise operatively coupled together. Other connections, mechanisms, features, functions, or the like, may be provided and adapted as necessary to operatively couple and configure a computing device 200. Furthermore, one or more of the features or functions illustrated in the example of FIG. 2 may be further subdivided, or two or more of the features or functions illustrated in FIG. 2 may be combined. Additionally, one or more of the features or functions illustrated in FIG. 2 may be excluded.

As shown, the computing device 200 can include a network interface 205 that can be configured to provide wired and/or wireless network connectivity to the computing device 200. The network interface can include one or more local area network transceivers that can be connected to one or more antennas (not shown). The one or more local area network transceivers comprise suitable devices, circuits, hardware, and/or software for communicating with and/or detecting signals to/from one or more of the wireless local area network (WLAN) access points, and/or directly with other wireless devices within a network. The network interface 205 can also include, in some implementations, one or more wide area network transceiver(s) that can be connected to the one or more antennas (not shown). The wide area network transceiver can comprise suitable devices, circuits, hardware, and/or software for communicating with and/or detecting signals from one or more of, for example, the wireless wide area network (WWAN) access points and/or directly with other wireless devices within a network. The network interface 205 can include a wired network interface instead of or in addition to one or more of the wireless network interfaces discussed above. The network interface 205 can be used to receive data from and send data to one or more other network-enabled devices via one or more intervening networks.

The processor(s) (also referred to as a controller) 210 may be connected to the memory 215, the secure communications unit 270, the user interface 250, and the network interface 205. The processor may include one or more microprocessors, microcontrollers, and/or digital signal processors that provide processing functions, as well as other calculation and control functionality. The processor 210 may be coupled to storage media (e.g., memory) 215 for storing data and software instructions for executing programmed functionality within the computing device. The memory 215 may be on-board the processor 210 (e.g., within the same IC package), and/or the memory may be external memory to the processor and functionally coupled over a data bus.

A number of software modules and data tables may reside in memory 215 and may be utilized by the processor 210 in order to manage, create, and/or remove content from the computing device 200 and/or perform device control functionality. As illustrated in FIG. 2, in some embodiments, the memory 215 may include an application module 220 which can implement one or more applications. It is to be noted that the functionality of the modules and/or data structures may be combined, separated, and/or be structured in different ways depending upon the implementation of the computing device 200. The application module 220 can comprise one or more trusted applications that can be executed by the trusted execution environment 280 of the computing device 200.

The application module 220 may be a process or thread running on the processor 210 of the computing device 200, which may request data from one or more other modules (not shown) of the computing device 200. Applications typically run within an upper layer of the software architectures and may be implemented in a rich execution environment of the computing device 200, and may include navigation applications, games, shopping applications, content streaming applications, web browsers, location aware service applications, etc.

The processor 210 may include a trusted execution environment 280. The trusted execution environment 280 can be used to implement a secure processing environment for executing secure software applications. The trusted execution environment 280 can be implemented as a secure area of the processor 210 that can be used to process and store sensitive data in an environment that is segregated from the rich execution environment in which the operating system and/or applications (such as those of the application module 220) may be executed. The trusted execution environment 280 can be configured to execute trusted applications that provide end-to-end security for sensitive data by enforcing confidentiality, integrity, and protection of the sensitive data stored therein. The trusted execution environment 280 can be used to store encryption keys, authentication information, and/or other sensitive data.

The computing device 200 may further include a user interface 250 providing suitable interface systems for outputting audio and/visual content, and for facilitating user interaction with the computing device 200. For example, the user interface 250 may comprise one or more of a microphone and/or a speaker for outputting audio content and for receiving audio input, a keypad and/or a touchscreen for receiving user inputs, and a display (which may be separate from the touchscreen or be the touchscreen) for displaying visual content. In some implementations, the computing device 200 may not include a user interface 250 and may instead be configured to interface with an external computing device that may be connected to the computing device 200 via a wired or wireless connection. The external computing device can be configured to provide a user interface for interacting with and configuring the computing device 200.

The secure communications unit 270 can provide the means for performing the various authentication processes recited herein and illustrated in FIGS. 1-12 depending upon the device in which the computing device 200 has been used to implement. The secure communications unit 270 can be used to establish a secure communication session with another computing device. The secure communications unit 270 can be configured to implement various secure communications protocols, including those discussed in the various example implementations discussed with respect to FIGS. 1-12. The secure communications unit 270 can be implemented in hardware, software, or a combination thereof. The functionality of the secure communications unit 270 can be implemented by hardware components of the trusted execution environment 280, the processor 210, or a combination thereof. The functionality of the secure communications unit 270 may also be implemented by processor executable code that is executed by the trusted execution environment 280 and/or the processor 210.

The computing device 200 can include sensor(s) 275. The sensor(s) 275 can comprise one or more sensors that can be used to assist to collect data that can be used to perform authentication to access and/or configure the computing device 200. The sensor(s) 275 can comprise sensors for obtaining biometric information to authenticate a user, such as a fingerprint sensor, an audio sensor for voice analysis, an optical sensor for performing retinal scans or for performing facial recognition, and/or other sensors for identifying other physiological and/or behavioral characteristics that can be used to authenticate a user of the computing device 200. The sensor(s) 275 can also include other types of sensors for collecting data from the environment proximate to the computing device 200 or about the computing device 200. For example, the sensor(s) 275 can comprise thermal sensors for collecting temperature information, accelerometers for collecting movement and/or shock information, magnetometers for collecting magnetic field information, other types of sensors, or a combination thereof. Other types of sensors can also be included in addition to or instead of those discussed above. The types of sensors utilized can depend upon how the computing device 200 is to be used and the environment in which the computing device 200 is configured to be deployed. For example, the computing device 200 may be an IoT device that is deployed in a remote or hazardous location, and is configured to periodically monitor conditions at that location and to provide information regarding these conditions to a server. The computing device 200 may be a medical device that is configured to periodically monitor the physiological condition of a user and to send that information to a medical professional. The computing device 200 is not limited to these particular examples, and could comprise other types of device that are used in other types of environments and report information to a server under other conditions.

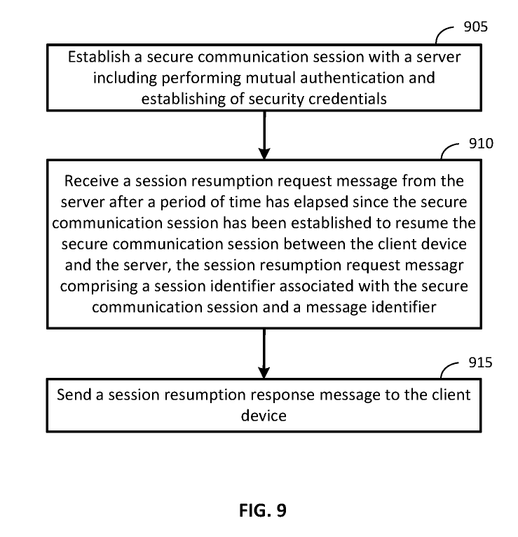

FIG. 3 is a signal flow diagram illustrating example interactions between a client device 120 and a server 105 to an DTLS session in accordance with certain example implementations. The example illustrated in FIG. 3 implements Datagram Transport Layer Security (DTLS) communications protocol for communicating between the client device 120 and the server 105. The client device 120 can be a LwM2M client, and the server 105 can be a LwM2M server. The DTLS session between the client device 120 and the server 105 includes a handshake phase comprising a negotiation phase and setting the cipher specification for use in subsequent encrypted communications between the client device 120 and the server 105. In the example illustrated in FIG. 3, the client device 120 initiates a request to establish a secure communication session with the server 105 using the DTLS protocol. The server 105 may also initiate the DTLS session, in which case, the handshake procedure would commence with a message from the server 105 to the client device 120, instead of the initial message originating from the client device 120 as in client-initiated example illustrated herein. While the example embodiment illustrated in FIG. 9 utilizes the DTLS protocol, the techniques disclosed herein can be used to establish secure communication sessions using other secure communication protocols.

The handshake process can be used to exchange various parameters that will be used to establish the DTLS session between the client device 120 and the server 105. The handshake process starts with a negotiation phase that includes stages 305, 310, 315, 320, 325, 330, 335, and 340. The client device 120 and the server 105 can be configured to undertake a negotiation process in which the client device 120 and the server 105 exchange information regarding the encryption capabilities of the client device 120 and the server 105. During this negotiation process, the client device 120 and the server 105 can exchange information that can be used to generate the encryption keys that can be used by the client device 120 and the server 105 to encrypt data to be exchanged during the DTLS session. The client device 120 and the server 105 can also be configured to determine a cipher suite to be used to encrypt the communications between the client device 120 and the server 105 during the DTLS session.

The client device 120 can send a “ClientHelloMessage” (stage 305) to the server 105. The ClientHelloMessage can include various parameters that can be used by the server 105 to establish the DTLS session with the client device 120. The ClientHelloMessage parameters can include an indicator identifying a highest DTLS protocol version supported by the client device 120. The parameters can also include a list of cipher suite list of cryptographic suites that are supported by the client device 120. The cipher suites can be listed in order of preference of the client device 120. Each cipher suite can define a key exchange algorithm, a bulk encryption algorithm (including secret key length), a Message Authentication Code (MAC) algorithm, and a Pseudorandom Function Family (PRF). The server 105 will ignore cipher suites that are not recognized or not supported by the server 105. If no acceptable choices are presented by the client device 120, the server 105 can be configured to return a handshake failure alert and to close the DTLS connection.

The example illustrated in FIG. 3 utilizes a cipher suite in which certificates are exchanged. However, the client device 120 and the server 105 can be configured to utilize a cipher suite that uses pre-shared keys (PSK). The client device 120 can indicate that the client device 120 is willing to utilize a PSK cipher suite by placing the PSK cipher suite in the ClientHello message. The ClientHelloMessage can be sent by the client device 120 when the client first attempts to connect to the server 105. The client device 120 can send the ClientHello under its own initiative or may send it in response to a HelloRequest message (not shown) from the server 105. The HelloRequest message serves as a simple notification that the client device 120 should begin the notification process with the server anew. The client device 120 should send the ClientHello message when convenient. The HelloRequest message is not used to establish which device is the client device and which device is the server for a particular DTLS session.

DTLS also uses a stateless cookie that is used, in part, to prevent denial-of-service (DOS) attacks. The client device 120 must return the cookie to the server for the server to proceed with the handshake process. At least two types of DOS attack may be prevented: (1) an attacker transmitting a series of handshake initiation requests to the server 105 which cause the server to perform expensive cryptographic operations; and (2) an attacker using the server 105 as an amplifier by sending connection initiation requests to the server with a forged source address of a victim. The latter type of DOS attack not only consumes server resources, but can also prompt the server 105 to flood the victim with a large amount of traffic.

The ClientHelloMessage can also include a session identifier (also referred to herein as a session ID or DTLS session ID) that can be used if the client is attempting to resume an existing DTLS session. If the session ID is valid and represents an existing session, the client device 120 and the server 105 can avoid having to engage in the steps discussed below for establishing session keys and the client device 120 and the server 105 can resume the session utilizing the existing session keys. The session ID can be left empty if no existing session has been established or if the client device 120 is attempting to establish new security parameters for a session with the server 105. The server 105 may, in some instances, not permit an existing session to be resumed. If the server 105 permits the session to be resumed, the response from the server will include the session ID and the session must be resumed using the same cipher suite that was originally negotiated for the session. If the session cannot be resumed, the server 105 may respond with a new session ID for a new session with the client device 120 or may respond with a black session ID for sessions that cannot be cached by the server 105 for later resumption.

The server 105 can respond to the ClientHelloMessage with a HelloVerifyRequest message (stage 310) that includes the server-generated stateless cookie. The client device 120 can then resend the ClientHelloMessage to the server 105 with the stateless cookie provided by the server 105 (stage 315). The server 105 can be configured to verify the authenticity of the cookie before proceeding with the handshake process. The server 105 can terminate the handshake process if the ClientHelloMessage is not retransmitted with the cookie or a valid cookie is not included with the ClientHelloMessage. The use of the cookies can prevent DOS attacks where the attacker attempts to flood the server 105 handshake initiation requests using spoofed network addresses. An attacker would be required to provide a valid network address in order to receive the HelloVerifyRequest from the server 105 and to return a ClientHelloMessage that includes the stateless cookie. In instances where the client device 120 is attempting to resume a session with the server 105, the client device 120 may include the stateless cookie and the session ID in the initial ClientHello message to the server if the client device 120 is configured such that the device is capable of maintaining the session state information. In some lightweight implementations of the client device 120, the client device may not be able to maintain the stateless cookie associated with the session and the server 105 can be configured to maintain the cookie and to return the cookie with the HelloVerifyRequest message that includes the stateless cookie. If the client device 120 was able to maintain the stateless cookie and provides the cookie with the ClientHelloMessage, the client device 120 can be configured to verify the authenticity of the cookie and does not need to return the cookie with the HelloVerifyRequest message.

The server 105 can respond to the second ClientHelloMessage that includes the stateless cookie with a ServerHelloMessage (stage 320). The ServerHelloMessage can include the chosen cipher suite, compression method, and version of DTLS to be used for the DTLS session. The selected version of DTLS can support a version of the DTLS that is equal to or less than the version of the DTLS protocol that the client device 120 indicated that the client device 120 could support in the ClientHelloMessage. The ServerHelloMessage can also include a nonce value, which can be a randomly generated number value, that can later be used to generate a master key that can be used to encrypt communications that are part of the DTLS session.

The ServerHelloMessage can indicate that the server 105 is willing to use a PSK cipher suite responsive to the server 105 including the PSK cipher suite in the ServerHelloMessage. The selection of a PSK cipher suite will alter the message flow from that illustrated in FIG. 3. The differences will be identified in the description of the subsequent messages that follow the ServerHelloMessage. Where a PSK cipher suite is utilized instead of a cipher suite that requires a certificate exchange, stages 325, 330, 335, and 340 will be omitted. Instead, the server 105 can send a ServerKeyExchange message and the client device 120 can respond with a ClientKeyExchange message (not shown). The ServerKeyExchange message can be sent by the server 105 to provide the client device 120 with a PSK hint that can be used by the client device 120 to identify which PSK to select for use in the DTLS session with the server 105. If no hint is provided, the ServerKeyExchange message can be send with a blank value in the hint field. The ClientKeyExchange message can be send by the client device 120 responsive to the ServerKeyExchange message and can identify which PSK is to be used in the DTLS session. If the ClientKeyExchange message includes a PSK that is not identifiable by the server 105, the server 105 can halt the handshake process and terminate the DTLS session with the client device 120.

Returning now to FIG. 3, the example implementation illustrated in FIG. 3 does utilize certificates rather than PSK. According, stages 325, 330, 335, and 340 are performed.

The server 105 can send a ServerCertificate message to the client device 120 (stage 325). The ServerCertificate message can include the server's public key. The client device 120 can be configured to use the public key to authenticate the server 105 and to encrypt the PreMasterSecret (discussed below).

The server 105 can also send a ClientCertificateRequest message to the client device 120 (stage 330) requesting that the client device 120 provide the client device's public key. The server 105 can use the public key of the client device 120 to authenticate the client device 120. The client device 120 can provide the public key of the client device 120 to the server in a ClientCertificate message (stage 335).

The client device 120 can also send a ClientKeyExchange message to the server 105 (stage 340). The client device 120 can be configured to generate a second nonce value, which can be a randomly generated number value. The client device 120 can then encrypt the second nonce value with the public key of the certificate of the server 105. The client device 120 can obtain the certificate from the server 105 via the ServerHelloMessage or via another message from the server 105. The client device 120 can use the cipher suite indicated in the ServerHelloMessage to encrypt the second nonce value using the public key of the server 105. The encrypted second nonce value can be sent to the server with the ClientKeyExchange message. The encrypted data can also be referred to as a “PreMasterSecret” value. The client device 120 and the server 105 can be configured to use the PreMasterSecret to compute a MasterSecret value. The MasterSecret value can be used to generate other key data. The client device 120 and the server 105 can be configured to pass the MasterSecret value through Pseudo-Random Number Generators (PRNGs) to generate key data to be used during the DTLS session.

The client device 120 can follow the ClientKeyExchange message with a ChangeCipherSpec message (stage 345). The ChangeCipherSpec can be used to signal to the server 105 that subsequent communications from client device 120 that are part of the TLS session will be encrypted using the session keys. The client device 120 can follow the ChangeCipherSpec message with a Finished message (stage 350). The Finished message can comprise contents encrypted using the key data generated during the negotiation phase with the server 105.

The server 105 can generate a ChangeCipherSpec message to the client device 120 responsive to receiving the Finished message from the client device 120 (stage 360). The server 105 can be configured to decrypt the Finished message from the client device 120 using the exchanged secret information. If the server 105 cannot successfully decrypt the contents of the finished message, the DTLS connection session can be halted and the connection between the client device 120 and the server 105 can be torn down, requiring the client device 120 to initiate a new DTLS session. Otherwise, if the server 105 successfully decrypts the contents of the Finished message from the client device 120, the server 105 can send the ChangeCipherSpec message to the client device 120. The server 105 can follow the ChangeCipherSpec message with a Finished message (stage 370). The contents of the Finished message are encrypted by the server 105 using the selected cipher suite. The client device 120 can decrypt the Finished message upon receipt, and if the client device 120 cannot decrypt the contents of the Finished message from the server 105, the TLS connection session can be halted and the connection between the client device 120 and the server 105 can be torn down, which would also require the client device 120 to initiate a new DTLS session. Otherwise, if the client device 120 can successfully decrypt the contents of the Finished message from the server, the TLS handshake is completed, and the client device 120 and the server 105 can communicate data over the TLS connection that has been encrypted using the keys generated during the handshake process and using the cipher suite selected during the handshake process.

Once the handshake process has been successfully completed, the client device 120 and the server 105 can exchange encrypted data using the DTLS session that has been established. As discussed above, the client device 120 can comprise an IoT device, and may be a LwM2M client. The client device 120 can be configured to periodically enter into a power saving mode (PSM) or other low power state in which the client device 120 may not be in communication with the server 105. The client device 120 can be configured to periodically exit the low power state and/or to exit the low power state in response to some event for which the client device is configured to exit the low power state. The client device 120 may have accumulated data to be communicated to the server 105, which can comprise a LwM2M server as discussed above. The client device 120 can also be configured to generate data to be transmitted to the server 105 upon exit from the low power state. For example, the client device 120 may be configured to report sensor data, a status of a medical device, and/or other types of data depending on the type of device and the configuration of said device to the server 105. However, the client device 120 can be configured to remain in the low power state for an extended period of time that the DTLS session may expire.

The server 105 configured to operate as a LwM2M server can be configured to support different operating modes for dealing with the client device 120 operating as an LwM2M client. In the UDP with Queue Mode (“UQ” mode), the server 105 is configured to queue all requests to the client device 120 and to send request to the client device via UDP when the client device is determined to be on-line. According to some implementations, the client device 120 can send a Constrained Application Protocol (CoAP) Register or Update command may be sent to the server 105 to indicate to the server that the client device 120 is online and is not powered down or operating in a PSM mode in which the client device 120 may not be able to receive data and/or commands from the server 105. In UQ mode, the server 105 must send request to the client device 120 using the UPD binding and the client device 120 must respond to such requests over the UDP binding. In UDP with Queue Mode and SMS (“UQS” mode”), the server 105 is configured to queue all requests to the client as in the UQ mode and to send the requests to the client device 120 is determined to be on-line. The server 105 is configured to expect that the client device 120 will be reachable via SMS at any time while operating in UQS mode. In UQS mode, if the server 105 sends a request to the client device 120 via the SMS binding, then the client device 120 is expected to respond to the server 105 via the SMS binding, and if the server 105 sends a request to the client device 120 via the UDP binding, the client device 120 is expected to respond to the server 105 via the UDP binding. For power constrained client devices, the UQ mode of operation may be preferable over the UQS mode, because keeping the SMS binding active and may require that the server send more packets to the client device 120 (versus using the UDP binding) and the processing of these additional SMS packets by the client device 120 also consume power, which could significantly shorten the battery life of the client device 120 over time. However, when operating under the UQ mode of operation, the server 105 may have to wait an extended period of time before data can be sent to the client device 120 or may have to wait an extended period of time before data is received from the client device 120. As a result, the DTLS session between the client device 120 and the server 105 may timeout. The server 105 may permit the DTLS session to resume, but may require that the client device 120 perform at least a portion of the handshake process with the server 105, up to and including a certificate exchange or selection of a PSK. According to some implementations, regardless of the mode of operation of the client device, the alerts used to resume a session as disclosed herein can be transmitted using the UDP binding.

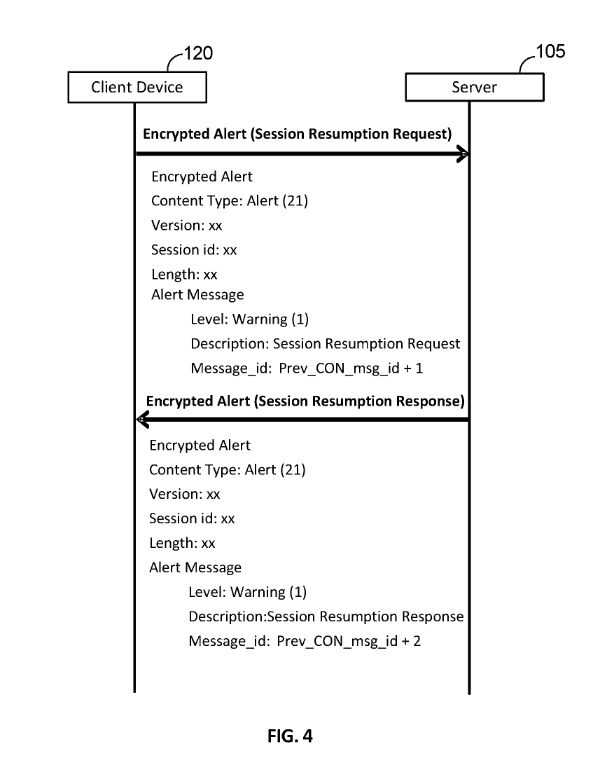

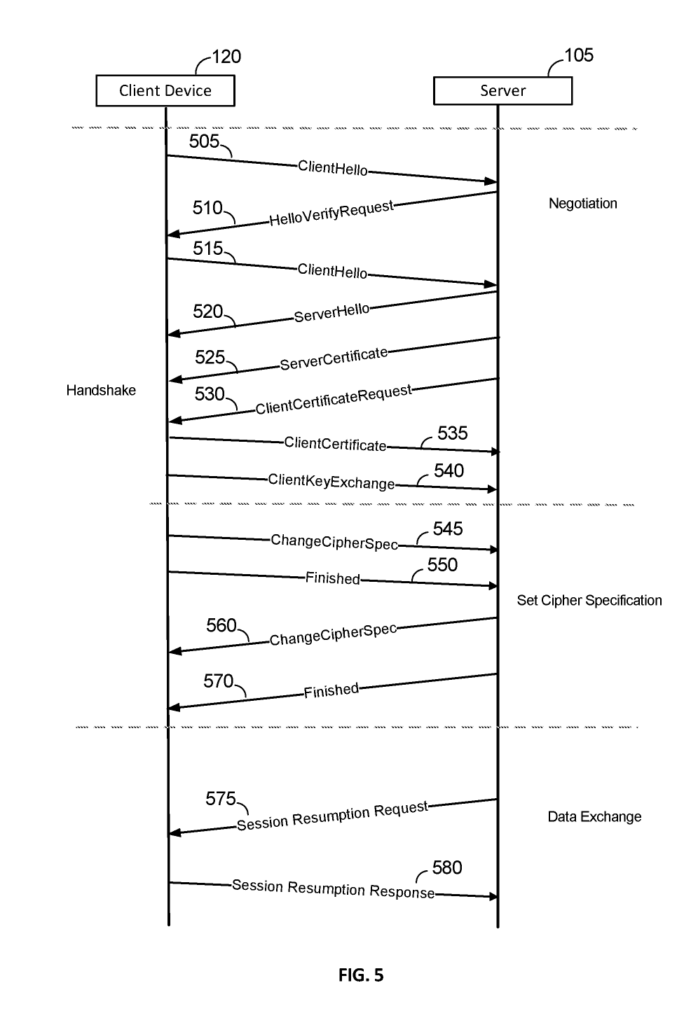

However, the client device 120 and the server 105 can be configured according to the techniques disclosed herein to allow for a resumption of the DTLS session. The resumption of the session may be triggered by either the client device 120 or the server 105. The examples illustrated in FIGS. 3 and 4 are client-initiated resumption of the DTLS session. The examples illustrated in FIGS. 4 and 5 are server-initiated resumption of the DTLS session. Data may be exchanged between the client device 120 and the server 105 after the handshake process has been completed and before stages 375 and 380 (discussed below) in which the DTLS session can be resumed. In some implementations, the client device 120 may enter in a low power or PSM mode periodically or in response to an event in order to conserve power. During this time, the client device 120 and/or the server 105 may accumulate data to be transmitted once the client device 120 exits the low power state. The client device 120 can also be configured to enter the low power state periodically and to perform one or more tasks, such as but not limited to data collection using the sensor(s) 275 and to generate data to be sent to the server 105. Depending upon the configuration of the client device 120 and the server 105, a significant amount of time can pass between exchanges of data between the client device 120 and the server 105. In a conventional DTLS session, the handshake process between the client device 120 and the server 105 would need to be repeated in order to mutually authenticate the client device 120 and the server 105. The following example discusses an example process for resuming the DTLS session between the client device and the server 105 that does not require the handshake process to be repeated.

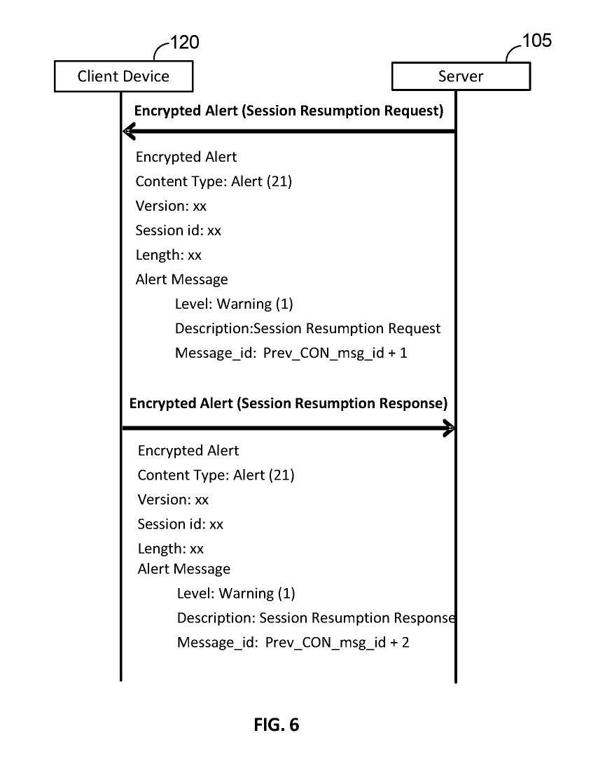

Continuing with FIG. 3, the client device 120 can send a session resumption request message to the server 105 (stage 375) and the server 105 can respond with a session resumption response message (stage 380). The session resumption request message and the session resumption response message can be implemented as TLS alert messages. FIG. 4 illustrates and example of the contents of such a session resumption request message and a session resumption response message for a client-initiated resumption of the DTLS session. A client device 120 can attempt to resume a session more than one time, and stages 375 and 380 may be repeated each time that the client device 120 attempts to resume the DTLS session with the server 105. Furthermore, server 105 can be configured to attempt to resume the DTLS session with the client device 120 (as discussed below with respect to FIGS. 5 and 6) one or more times. Such requests to resume the session may originate one or more times from the client device 120, the server 105, or both over the course of a DTLS session and requests from the client device 120 and the server 105 may be interleaved with one another such that the client device 120 may initiate some requests while the server 105 initiates other requests. The device which initiates the session resumption request process can be determined based on which device has data to exchange with the other device.

The TLS alert message are encrypted message that can be transmitted to convey information between the client device 120 and the server 105 in either direction. TLS alert messages can be configured to include a severity level indicator. TLS alert messages that include a “fatal” level indicator can be used to convey information regarding the occurrence of an event that requires the immediate termination of the DTLS session. TLS alert messages that includes a “warning” level indicator can be used to convey information regarding an event that does not require the immediate termination of the DTLS session. The description field of the TLS alert message can be set to indicate whether the alert is a session resumption request message or a session resumption response message. The session ID field of the alert message is set to the session ID of the DTLS session that the client device 120 is attempting to resume. The TLS alert message from the server 105 that comprises the session resumption response can include this session ID if the server 105 agrees to resume the session without performing another handshake with the client device 120. Otherwise, the session ID included in the alert message comprising the session resumption response can include a blank or empty session ID, indicating to the client device 120 that the session cannot be resumed a full handshake must be performed with the server 105. The session ID field is not encrypted.

The session resumption request can include in the message ID field a message identifier value that is incremented a predetermined amount from the message ID of the last message exchanged as part of the DTLS session prior to the attempt to resume the session. In the example illustrated in FIG. 4, the previous message ID is incremented by 1 by the client device 120 in the session resumption request and the previous message ID is incremented by 2 by the server 105 in the session resumption response. The message ID field is part of the encrypted content of the alert message and cannot be easily modified by an attacker attempting to circumvent the authentication process by resuming a previously authenticated session. Both the client device 120 and the server 105 should be aware of the message ID of the previous message that was exchanged between the devices during the DTLS session. The receiving device can decrypt the encrypted contents of the alert message and determine whether the message ID has been incremented by an expected amount. If the decrypted value of the message ID matches the expected value, then the receiving device can safely determine that the alert message comprising the session resumption request or the session resumption response originated with the purported sender of the alert message and the handshake process does not need to be repeated. If there is a mismatch between the decrypted value and the expected value, the receiving device can require that handshake process be performed again to mutually re-authenticate the server 105 and the client device 120.

While the example implementation discussed herein use a numeric message ID value in the session resumption request message and the session resumption response message, the message ID field can comprise any alphanumeric or numeric value that can be used by the client device 120 and the server 105 to determine that a session resumption request is legitimate. For example, the message ID field can comprise an alphanumeric string that is randomly or pseudo-randomly generated at the start of the secure communication session by the client device 120 or the server 105. In implementations where the message ID comprises an alphanumeric value, the client device 120 and the server 105 can be configured to “increment” a last know the value of the message ID by altering the alphanumeric value of the string in a predetermined manner. For example, one or more characters of the alphanumeric string can be modified according to a predetermined pattern. The incrementing done to the alphanumeric value need not increment the same one or more characters of the alphanumeric value each time or by the same amount, so long as both the client device 120 and the server 105 have information as to how the message ID will be incremented.

The use of alerts to convey the session resumption request message and the session resumption response message can provide a significant advantage over conventional DTLS resumption techniques. DTLS provides a session resumption technique in which at least a portion of the handshake process is repeated in order to allow the client device 120 to continue with an earlier established session with the server 105. In conventional DTLS implementations, the client device can resume the DTLS session with the server by transmitting the ClientHello message (from stage 305) with the sessionID of the session that the client device 120 is attempting to resume. The server 105 can be configured to respond with the ServerHello message (from stage 310). The server 105 may also send a ChangeCipherSpec message (similar to stage 360) that indicates that the subsequent communications from the server 105 that are part of the DTLS session will be encrypted using the session keys. The server may follow the ChangeCipherSpec message with a Finished message (similar to that of stage 370) that may comprise contents encrypted using the key data generated during the negotiation phase of the handshake process with the client device 120. The client device may also send a ChangeCipherSpec message (similar to stage 345) that indicates that the subsequent communications to the server 105 that are part of the DTLS session will be encrypted using the session keys. The client device 120 may follow the ChangeCipherSpec message with a Finished message (similar to that of stage 350) that may comprise contents encrypted using the key data generated during the negotiation phase of the handshake process with the server 105.

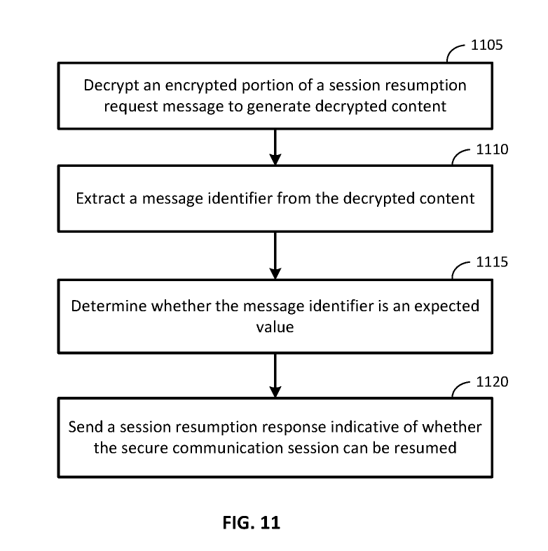

The server 105 can be configured to authenticate the session resumption request message received from the client device 120. FIG. 11 illustrates an example process which the server 105 can be configured to use to authenticate the session resumption request message received from the client device 120. The server 105 can be configure to decrypt an encrypted portion of the session resumption request message to generate the decrypted content. The cryptographic keys to be used for encrypting data exchanged between the server 105 and the client device 120 should have been determined during the handshake process. The session resumption request message can be sent to the server 105 as an alert message as illustrated in FIG. 4. The session ID of the session to be resumed is included in the session ID field of the alert message. The session ID field of the alert message is included in the unencrypted portion of the alert message. The server 105 can use the session ID to determine which session the alert message pertains to and can select the appropriate cryptographic key to decrypt the encrypted portion of the alert message. The server 105 can then decrypt the encrypted portion of the alert message (stage 1105) to produce decrypted content. The message ID can then be extracted from the decrypted content (stage 1110). The server 105 can also be configured to extract the description field from the alert message. The description field should comprise content that indicates that the alert message is a session resumption request message. If the description indicates that the alert does not comprise a session resumption request message, the server 105 can be configured to apply the appropriate processing to the type of message identified in the description field. If the description field indicates that the alert message comprises a session resumption request message, then the server 105 can be configured to determine whether the message ID extracted from the decrypted content matches an expected value (stage 1115). The expected value can be determined based on the message ID of the previous message exchanged between the client device 120 and the server 105 in the DTLS session. The message ID from the previous message can be incremented by a predetermined amount by the client device 120 and be included in the encrypted portion of the alert message comprising the session resumption request message. In the example illustrated in FIG. 4, the message ID from the previous message is incremented by 1, but in other implementations, the message ID may be incremented by a different amount that is expected by the server 105 and the client device. A value other than 1 may be selected as the increment amount in order to make it more difficult for a session resumption request message to be forged by an attacker.

The server 105 can then be configured to send a session resumption response message to the client device 120 indicative of whether the secure communication session can be resumed (stage 1120). As discussed above with respect to FIG. 4, the session resumption response message can also be implemented as a TLS alert message. The server 105 can be configured to allow the session to be resumed responsive to the session ID matching a previously established session between the client device 120 and the server 105 and the message ID matching the expected value for the message ID. The server 105 can include the session ID in the session resumption response message and include in the encrypted portion of the alert message the message ID which has been incremented a predetermined amount from the previous message ID from the last message exchanged in the DTLS session prior to the session resumption request message from the client device 120. In the example implementation illustrated in FIG. 4, the server 105 increments the message ID from the last message exchanged in the DTLS session by 2 (or the message ID from the request from the client by 1). The actual amount that the client device 120 and the client device 120 increment the message ID is not limited to 1 and may be any amount that is expected by both the client device 120 and the client device 120. Furthermore, the client device 120 and the server 105 may be configured to increment the message ID by a different predetermined amount to make falsification of the a session resumption request message or session resumption response message more difficult. And, as also discussed above, the message ID can be an alphanumeric value rather than a numeric one, and the message ID value may be incremented by altering this alphanumeric value in a predetermined way.

The server can be configured to deny the request to resume a DTLS session if the previous session has been terminated due to a fatal error that would require that a new handshake process be performed between the client device 120 and the server 105. The server 105 can also be configured to deny the request to resume the DTLS session responsive to the server 105 requiring that a handshake be performed. The server 105 can be configured to require that a new handshake be performed based on various criteria, such as how much time has elapsed since the client device 120 has last exchanged a message as part of the DTLS session. The server can set the session ID field to a blank or zero value responsive to the session not being able to be resumed. The server can also set the message ID field to a blank or zero value responsive to the DTLS session not being able to be resumed.

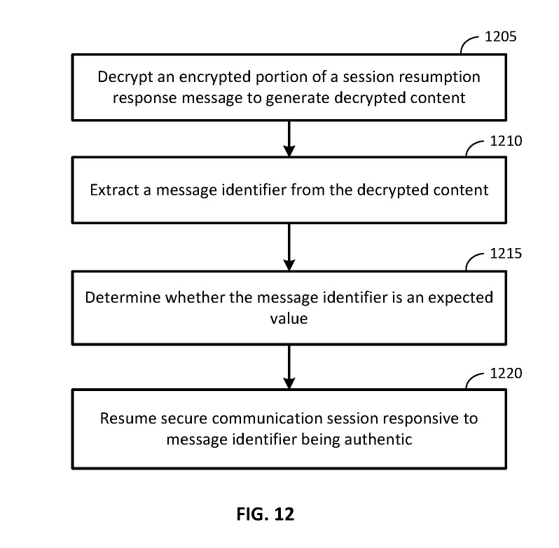

The client device 120 can be configured to authenticate the session resumption response message received from the server 105. FIG. 12 illustrates an example process which the server 105 can be configured to use to authenticate the session resumption request message received from the client device 120. The client device 120 can be configure to decrypt an encrypted portion of the session resumption response message to generate the decrypted content. The cryptographic keys to be used for encrypting data exchanged between the server 105 and the client device 120 should have been determined during the handshake process. The session resumption response message can be sent to the client device 120 as an alert message as illustrated in FIG. 4. The session ID of the session to be resumed is included in the session ID field of the alert message. The session ID field of the alert message is included in the unencrypted portion of the alert message. The client device 120 can use the session ID to determine which session the alert message pertains to and can select the appropriate cryptographic key to decrypt the encrypted portion of the alert message. If the session ID of the session resumption response message is blank, then the server 105 has indicated that the session cannot be resumed. The client device 120 can be configured to perform the handshake process with the server 105 in order to establish a new DTLS session between the client device 120 and the server 105.

The client device 120 can then decrypt the encrypted portion of the alert message (stage 1205) to produce decrypted content. The message ID can then be extracted from the decrypted content (stage 1210). The client device 120 can also be configured to extract the description field from the alert message. The description field should comprise content that indicates that the alert message is a session resumption response message. If the description indicates that the alert does not comprise a session resumption request message, the client device 120 can be configured to apply the appropriate processing to the type of message identified in the description field, and can also be configured to initiate the handshake process with the server 105 in order to establish a DTLS session with the server 105. If the description field indicates that the alert message comprises a session resumption response message, then the client device 120 can be configured to determine whether the message ID extracted from the decrypted content matches an expected value (stage 1215). The expected value can be determined based on the message ID of the previous message exchanged between the client device 120 and the server 105 in the DTLS session prior to the attempted resumption of the DTLS session by the client device 120. The message ID from the previous message can be incremented by a predetermined amount by the server 105 and be included in the encrypted portion of the alert message comprising the session resumption request message. In the example illustrated in FIG. 4, the message ID from the previous message is incremented by 2, but in other implementations, the message ID may be incremented by a different amount that is expected by the server 105 and the client device. A value other than 1 may be selected as the increment amount in order to make it more difficult for a session resumption request message to be forged by an attacker. And, as also discussed above, the message ID can be an alphanumeric value rather than a numeric one, and the message ID value may be incremented by altering this alphanumeric value in a predetermined way.

The client device 120 can be configured to resume the secure communication session with the server 105 responsive to the session resumption response message indicating that the session can be resumed (stage 1220). The client device can resume the secure communication session responsive to the session ID matching the session ID for which the resumption was requested and the message ID included in the session resumption response message matching the expected value. The resumption of the session between the client device 120 and the server 105 can include the client device 120 sending encrypted data to the server 105. The server 105 can also send encrypted data to the client device 120.

FIG. 5 is a signal flow diagram illustrating example interactions between a client device 120 and a server 105 to an DTLS session in accordance with certain example implementations. The example illustrated in FIG. 5 implements Datagram Transport Layer Security (DTLS) communications protocol for communicating between the client device 120 and the server 105 and is similar to that of FIG. 3. However, in the example illustrated in FIG. 5, the server 105 attempts to resume the DTLS session established with the client device 120 once the DTLS session has been established between the two devices. The server 105 may attempt to resume the session in order to send data and/or commands to the client device 120 using the DTLS session that was previously established between the server 105 and the client device 120.

The handshake process illustrated in FIG. 5 is similar to that of FIG. 3. Stage 505 is similar to that of stage 305. Stage 510 is similar to that of stage 310. Stage 515 is similar to that of stage 315. Stage 520 is similar to that of stage 320. Stage 525 is similar to that of stage 325. Stage 530 is similar to that of stage 330. Stage 535 is similar to that of stage 335. Stage 540 is similar to that of stage 340. Stage 545 is similar to that of stage 345. Stage 550 is similar to that of stage 350. Stage 560 is similar to that of stage 360. Stage 570 is similar to that of stage 370.

In contrast with the example process illustrated in FIG. 3 in which the client device 120 initiates the session resumption, the server 105 initiates the session resumption in the example process illustrated in FIG. 5. The server 105 can send a session resumption request message to the client device 120 (stage 575) and the client device 120 can respond with a session resumption response message (stage 580). The session resumption request message and the session resumption response message can be implemented as TLS alert messages. FIG. 4 illustrates and example of the contents of such a session resumption request message and a session resumption response message for a client-initiated resumption of the DTLS session. The server 105 can be configured to attempt to resume the DTLS session with the client device 120 one or more times, and stages 575 and 580 may be repeated each time that the server 105 attempts to resume the DTLS session with the client device 120. Furthermore, the client device 120 can attempt to resume a session more than one time (as discussed below with respect to FIGS. 3 and 4). Such requests to resume the session may originate one or more times from the client device 120, the server 105, or both over the course of a DTLS session and requests from the client device 120 and the server 105 may be interleaved with one another such that the client device 120 may initiate some requests while the server 105 initiates other requests. The device which initiates the session resumption request process can be determined based on which device has data to exchange with the other device.

The client device 120 can be configured to authenticate the session resumption request message received from the server 105. FIG. 11 illustrates an example process which the client device 120 can be configured to use to authenticate the session resumption request message received from the server 105. The client device 120 can be configure to decrypt an encrypted portion of the session resumption request message to generate the decrypted content. The cryptographic keys to be used for encrypting data exchanged between the server 105 and the client device 120 should have been determined during the handshake process for establishing the DTLS session. The session resumption request message can be sent to the client device 120 as an alert message as illustrated in FIG. 6. The session ID of the session to be resumed is included in the session ID field of the alert message. The session ID field of the alert message is included in the unencrypted portion of the alert message. The client device 120 can be configured to use the session ID to determine which session the alert message pertains to and can select the appropriate cryptographic key to decrypt the encrypted portion of the alert message. The client device 120 can then decrypt the encrypted portion of the alert message (stage 1105) to produce decrypted content. The message ID can then be extracted from the decrypted content (stage 1110). The client device 120 can also be configured to extract the description field from the alert message. The description field should comprise content that indicates that the alert message is a session resumption request message. If the description indicates that the alert does not comprise a session resumption request message, the client device 120 can be configured to apply the appropriate processing to the type of message identified in the description field. If the description field indicates that the alert message comprises a session resumption request message, then the client device 120 can be configured to determine whether the message ID extracted from the decrypted content matches an expected value (stage 1115). The expected value can be determined based on the message ID of the previous message exchanged between the client device 120 and the server 105 in the DTLS session. The message ID from the previous message can be incremented by a predetermined amount by the server 105 and be included in the encrypted portion of the alert message comprising the session resumption request message. In the example illustrated in FIG. 6, the message ID from the previous message is incremented by 1, but in other implementations, the message ID may be incremented by a different amount that is expected by client device 120 and the server 105. A value other than 1 may be selected as the increment amount in order to make it more difficult for a session resumption request message to be forged by an attacker. The client device 120 can determine whether the DTLS session can be resumed based on the message ID matching an expected value. As discussed above, the message ID can comprise a numeric or alphanumeric value and may have been incremented by the server 105 by an expected amount. If the received message ID does not match the expected message ID, the client device 120 can be configured to determine that the secure communication session cannot be resumed or cannot be resumed without performing a handshake with the server 105.

The client device 120 be configured to send a session resumption response message to the server 105 indicative of whether the secure communication session can be resumed (stage 1120). As discussed above with respect to FIG. 6, the session resumption response message can also be implemented as a TLS alert message. The client device 120 can be configured to allow the session to be resumed responsive to the session ID matching a previously established session between the client device 120 and the server 105 and the message ID matching the expected value for the message ID. The client device 120 can include the session ID in the session resumption response message and include in the encrypted portion of the alert message the message ID which has been incremented a predetermined amount from the previous message ID from the last message exchanged in the DTLS session prior to the session resumption request message from the server 105. In the example implementation illustrated in FIG. 6, the client device 120 increments the message ID from the last message exchanged in the DTLS session by 2 (or the message ID from the server 105 from the client by 1). The actual amount that the client device 120 and the client device 120 increment the message ID is not limited to 1 and may be any amount that is expected by both the client device 120 and the client device 120. Furthermore, the client device 120 and the server 105 may be configured to increment the message ID by a different predetermined amount to make falsification of the a session resumption request message or session resumption response message more difficult. As discussed above, the message ID may also comprise an alphanumeric string rather than a numeric value, and the alphanumeric value can be “incremented” by altering the alphanumeric string in a predetermined manner known to the server 105 and the client device 120.

The client device 120 can be configured to deny the request to resume a DTLS session if the previous session has been terminated due to a fatal error that would require that a new handshake process be performed between the client device 120 and the server 105. The client device 120 can also be configured to deny the request to resume the DTLS session responsive to the client device 120 requiring that a handshake be performed. The client device 120 can be configured to require that a new handshake be performed based on various criteria, such as how much time has elapsed since the server 105 has last exchanged a message with the client device 120 as part of the DTLS session. The client device 120 can set the session ID field to a blank or zero value responsive to the session not being able to be resumed. The client device 120 can also set the message ID field to a blank or zero value responsive to the DTLS session not being able to be resumed.

The server 105 can be configured to authenticate the session resumption response message received from the client device. FIG. 12 illustrates an example process which the server 105 can be configured to use to authenticate the session resumption request message received from the client device 120. The server 105 can be configure to decrypt an encrypted portion of the session resumption response message to generate the decrypted content. The cryptographic keys to be used for encrypting data exchanged between the server 105 and the client device 120 should have been determined during the handshake process for the session. The session resumption response message can be sent to the server 105 by the client device 120 as an alert message as illustrated in FIG. 6. The session ID of the session to be resumed is included in the session ID field of the alert message. The session ID field of the alert message is included in the unencrypted portion of the alert message. The server 105 can use the session ID to determine which session the alert message pertains to and can select the appropriate cryptographic key to decrypt the encrypted portion of the alert message. If the session ID of the session resumption response message is blank, then the client device 120 has indicated that the session cannot be resumed. The server 105 can be configured to perform the handshake process with the client device 120 in order to establish a new DTLS session between the client device 120 and the server 105.

The server 105 can then decrypt the encrypted portion of the alert message (stage 1205) to produce decrypted content. The message ID can then be extracted from the decrypted content (stage 1210). The server 105 can also be configured to extract the description field from the alert message. The description field should comprise content that indicates that the alert message is a session resumption response message. If the description indicates that the alert does not comprise a session resumption request message, the server 105 can be configured to apply the appropriate processing to the type of message identified in the description field, and can also be configured to initiate the handshake process with the client device 120 in order to establish a DTLS session with the client device 120. If the description field indicates that the alert message comprises a session resumption response message, then the server 105 can be configured to determine whether the message ID extracted from the decrypted content matches an expected value (stage 1215). The expected value can be determined based on the message ID of the previous message exchanged between the client device 120 and the server 105 in the DTLS session prior to the attempted resumption of the DTLS session by the server 105. The message ID from the previous message can be incremented by a predetermined amount by the client device 120 and be included in the encrypted portion of the alert message comprising the session resumption request message. In the example illustrated in FIG. 6, the message ID from the previous message is incremented by 2, but in other implementations, the message ID may be incremented by a different amount that is expected by the server 105 and the client device 120. A value other than 1 may be selected as the increment amount in order to make it more difficult for a session resumption request message to be forged by an attacker. And, as also discussed above, the message ID can be an alphanumeric value rather than a numeric one, and the message ID value may be incremented by altering this alphanumeric value in a predetermined way.

The server 105 can be configured to resume the secure communication session with the client device 120 responsive to the session resumption response message indicating that the session can be resumed (stage 1220). The server 105 can resume the secure communication session responsive to the session ID matching the session ID for which the resumption was requested and the message ID included in the session resumption response message matching the expected value. The resumption of the session between the client device 120 and the server 105 can include the server 105 sending encrypted data to the client device 120. The client device 120 can also send encrypted data to the server 105.

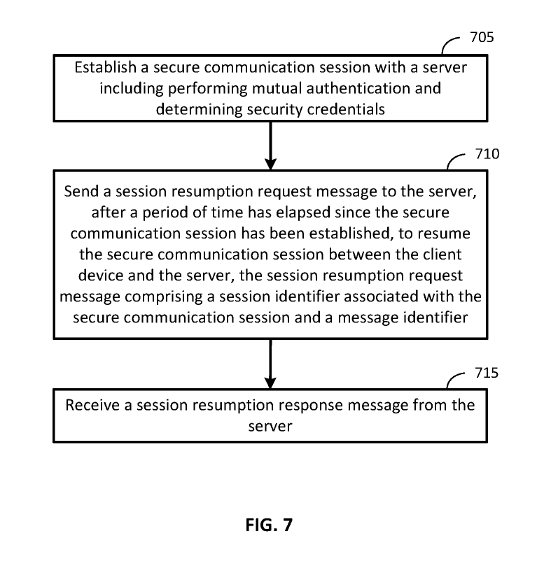

FIG. 7 is an illustration of an example process for a client-initiated resumption of a secure communication session on a client device according to the techniques disclosed herein. The process illustrated in FIG. 7 can be implemented by a client device, such as the client device 120. The secure communications unit 270 of the client device 120 can provide the means for performing the various stages of the process illustrated herein unless otherwise specified.

A secure communication session can be established with a server (stage 705). Establishing the secure communication session with the server 105 can include performing mutual authentication and determining security credentials for use in ensuring the data exchanged during the secure communication session remains protected from unauthorized access. The establishing of the secure communication session can be similar to the handshake process undertake in the processes illustrated in FIGS. 3 and 5 in which the client device 120 and the server 105 perform a negotiation phase and a set cipher specification phase when establishing a DTLS session. Other types of mutual authentication processes may be performed according to requirement of the secure communications protocol under which the client device 120 and the server 105 are attempting to establish a secure communication session. As discussed above, the client device 120 can be a LwM2M client and the server 105 can be a LwM2M server. The client device 120 or the server 105 can initiate the handshake process to establish the secure communication session between the client device 120 and the server 105.

A session resumption request message can be sent to the server after a period of time has elapsed since the secure communication session has been established (stage 710). The session resumption request message can be sent by the client device 120 to the server 105 in an attempt by the client device 120 to resume the secure communication session established in stage 705. The session resumption request message can be similar to that illustrated in FIG. 4. The session resumption message can be a TLS alert message. The session resumption request message can include the session ID of the session that the client device 120 is attempting to resume. A client device 120 may have ongoing sessions with multiple servers simultaneously. The session ID may be unique for each of the sessions that are pending for the client device 120 and/or the server 105. The session resumption request message can also include a message identifier (message ID) that has been incremented a predetermined amount from a last previous message exchanged between the client device 120 and the server 105 in the secure communication session. How the message ID may be incremented is discussed in greater detail with respect to FIGS. 3 and 4. Furthermore, at least a portion of the message can be encrypted using cryptographic key(s) associated with the secure communication session as discussed FIGS. 3 and 4.

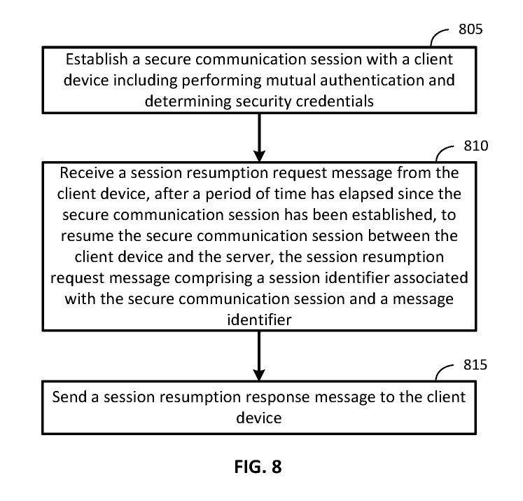

A session resumption response message can be received from the server (stage 715). The server 105 can respond to the session resumption request message with a session resumption response message as discussed in detail with respect to FIG. 8. The client device 120 can execute a new handshake process with the server 105 responsive to the session resumption response message indicating that the server 105 cannot resume the secure communication session. The client device 120 can begin exchanging data with the server 105 responsive to the session resumption response message indicating that the secure communication session can be resumed. The client device 120 can be configured to authenticate the session resumption response message received from the server 105 using the process illustrated in FIG. 12, and the client device 120 can be configured to initiate a new handshake process with the server 105 responsive to the client device 120 being unable to authenticate the session resumption response message. The session resumption response message can be a TLS alert, as discussed with respect to FIGS. 3 and 4.

FIG. 8 is an illustration of an example process for a client-initiated resumption of a secure communication session on a server according to the techniques disclosed herein. The process illustrated in FIG. 8 can be implemented by a server, such as the server 105. The secure communications unit 270 of the server 105 can provide the means for performing the various stages of the process illustrated herein unless otherwise specified.

A secure communication session can be established with a client device 120 (stage 805). Establishing the secure communication session with the client device 120 can include performing mutual authentication and determining security credentials for use in ensuring the data exchanged during the secure communication session remains protected from unauthorized access. The establishing of the secure communication session can be similar to the handshake process undertake in the processes illustrated in FIGS. 3 and 5 in which the client device 120 and the server 105 perform a negotiation phase and a set cipher specification phase when establishing a DTLS session. Other types of mutual authentication processes may be performed according to requirement of the secure communications protocol under which the client device 120 and the server 105 are attempting to establish a secure communication session. As discussed above, the client device 120 can be a LwM2M client and the server 105 can be a LwM2M server. The client device 120 or the server 105 can initiate the handshake process to establish the secure communication session between the client device 120 and the server 105.

A session resumption request message can be received from the client device (stage 810). The session resumption request message can be sent by the client device 120 after a period of time has elapsed since the secure communication session has been established. The session resumption request message can be used by the client device 120 to request that the secure communication session established in stage 805 be resumed. The session resumption request message can be similar to that illustrated in FIG. 4. The session resumption message can be a TLS alert message. The session resumption request message can include the session ID of the session that the client device 120 is attempting to resume. The session resumption request message can also include a message identifier (message ID) that has been incremented a predetermined amount from a last previous message exchanged between the client device 120 and the server 105 in the secure communication session. How the message ID may be incremented is discussed in greater detail with respect to FIGS. 3 and 4. At least a portion of the message can be encrypted using cryptographic key(s) associated with the secure communication session as discussed FIGS. 3 and 4. The server 105 can be configured to authenticate the session resumption request message using the example process illustrated in FIG. 11.

A session resumption response message can be sent to the client device 120 (stage 815). The server 105 can be configured to send a session resumption response message that indicates whether the server 105 can resume the secure communication session with the client device 120 without requiring the client device 120 perform a full handshake with the server 105. The server 105 can be configured to determine that the secure communication session can be resumed with the client device 120 based on authenticating the session resumption request message received from the client device 120. The session resumption message can comprise a TLS alert similar to that discussed with respect to FIGS. 3 and 4.

FIG. 9 is an illustration of an example process for a server-initiated resumption of a secure communication session on a client device according to the techniques disclosed herein. The process illustrated in FIG. 9 can be implemented by a client device, such as the client device 120. The secure communications unit 270 of the client device 120 can provide the means for performing the various stages of the process illustrated herein unless otherwise specified.

A secure communication session can be established with a server (stage 905). Establishing the secure communication session with the server 105 can include performing mutual authentication and determining security credentials for use in ensuring the data exchanged during the secure communication session remains protected from unauthorized access. The establishing of the secure communication session can be similar to the handshake process undertake in the processes illustrated in FIGS. 3 and 5 in which the client device 120 and the server 105 perform a negotiation phase and a set cipher specification phase when establishing a DTLS session. Other types of mutual authentication processes may be performed according to requirement of the secure communications protocol under which the client device 120 and the server 105 are attempting to establish a secure communication session. As discussed above, the client device 120 can be a LwM2M client and the server 105 can be a LwM2M server. The client device 120 or the server 105 can initiate the handshake process to establish the secure communication session between the client device 120 and the server 105.

A session resumption request message can be received from the server (stage 910). The session resumption request message can be sent by the client device 120 after a period of time has elapsed since the secure communication session has been established. The session resumption request message can be used by the server 105 to request that the secure communication session established in stage 905 be resumed. The session resumption request message can be similar to that illustrated in FIG. 6. The session resumption message can be a TLS alert message. The session resumption request message can include the session ID of the session that the server 105 is attempting to resume. The session resumption request message can also include a message identifier (message ID) that has been incremented a predetermined amount from a last previous message exchanged between the client device 120 and the server 105 in the secure communication session. How the message ID may be incremented is discussed in greater detail with respect to FIGS. 5 and 6. At least a portion of the message can be encrypted using cryptographic key(s) associated with the secure communication session as discussed FIGS. 5 and 6. The server 105 can be configured to authenticate the session resumption request message using the example process illustrated in FIG. 11.

A session resumption response message can be sent to the server (stage 915). The client device 120 can be configured to send a session resumption response message that indicates whether the client device 120 can resume the secure communication session with the server 105 without requiring the client device 120 perform a full handshake with the server 105. The client device 120 can be configured to determine that the secure communication session can be resumed with the client device 120 based on authenticating the session resumption request message received from the client device 120. The session resumption message can comprise a TLS alert similar to that discussed with respect to FIGS. 5 and 6.

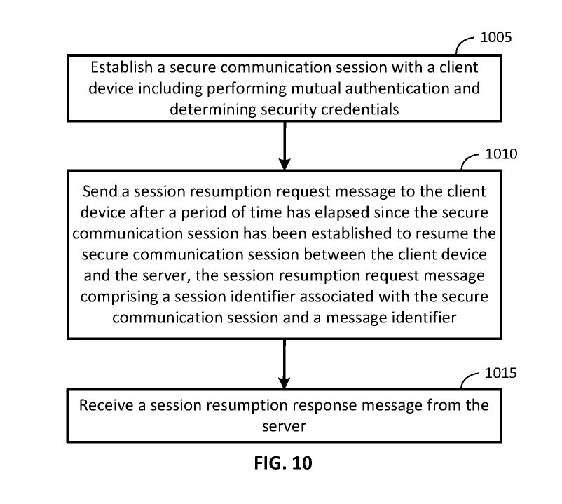

FIG. 10 is an illustration of an example process for a server-initiated resumption of a secure communication session on a server according to the techniques disclosed herein. The process illustrated in FIG. 8 can be implemented by a server, such as the server 105. The secure communications unit 270 of the server 105 can provide the means for performing the various stages of the process illustrated herein unless otherwise specified.

A secure communication session can be established with a client device 120 (stage 1005). Establishing the secure communication session with the client device 120 can include performing mutual authentication and determining security credentials for use in ensuring the data exchanged during the secure communication session remains protected from unauthorized access. The establishing of the secure communication session can be similar to the handshake process undertake in the processes illustrated in FIGS. 3 and 5 in which the client device 120 and the server 105 perform a negotiation phase and a set cipher specification phase when establishing a DTLS session. Other types of mutual authentication processes may be performed according to requirement of the secure communications protocol under which the client device 120 and the server 105 are attempting to establish a secure communication session. As discussed above, the client device 120 can be a LwM2M client and the server 105 can be a LwM2M server. The client device 120 or the server 105 can initiate the handshake process to establish the secure communication session between the client device 120 and the server 105.

A session resumption request message can be sent to the client device after a period of time has elapsed since the secure communication session has been established (stage 1010). The session resumption request message can be sent to the client device 120 in an attempt to resume the secure communication session established in stage 1005. The session resumption request message can be similar to that illustrated in FIG. 6. The session resumption message can be a TLS alert message. The session resumption request message can include the session ID of the session that the server 105 is attempting to resume. A server 105 may have ongoing sessions with multiple client devices simultaneously. The session ID may be unique for each of the sessions that are pending for the client device 120 and/or the server 105. The session resumption request message can also include a message identifier (message ID) that has been incremented a predetermined amount from a last previous message exchanged between the client device 120 and the server 105 in the secure communication session. How the message ID may be incremented is discussed in greater detail with respect to FIGS. 5 and 6. Furthermore, at least a portion of the message can be encrypted using cryptographic key(s) associated with the secure communication session as discussed FIGS. 5 and 6.

A session resumption response message can be received from the client device (stage 1015). The client device 120 can respond to the session resumption request message with a session resumption response message. The server 105 can execute a new handshake process with the client device 120 responsive to the session resumption response message indicating that the client device 120 cannot resume the secure communication session. The server 105 can begin exchanging data with the client device 120 responsive to the session resumption response message indicating that the secure communication session can be resumed. The server 105 can be configured to authenticate the session resumption response message received from the client device 120 using the process illustrated in FIG. 12, and the server 105 can be configured to initiate a new handshake process with the client device 120 responsive to the server 105 being unable to authenticate the session resumption response message. The session resumption response message can be a TLS alert, as discussed with respect to FIGS. 5 and 6.

Example implementations according to the disclosure include the following:

E1. An example method for managing data communications comprising:

establishing, by a client device, a secure communication session with a server including performing mutual authentication and determining security credentials; and

receiving a session resumption request message from the server after a period of time has elapsed to resume the secure communication session between the client device and the server without repeating at least a portion of the mutual authentication between the client device and the server, the session resumption request message comprising a session identifier associated with the secure communication session and a message identifier.

E2. The method of example E1, further comprising:

authenticating the session resumption request message from the server by
decrypting an encrypted portion of the session resumption request message from the server using cryptographic keys associated with the security credentials for the server to generated decrypted content;
extracting a message identifier from the decrypted content; and
determining whether the message identifier is an expected value.
   E3. The method of example E2, further comprising:

sending a session resumption response message to the server responsive to authenticating the session resumption request message.

E4. The method of example E3, further comprising:

encrypting at least a portion of the session resumption response message using a cryptographic key associated with the security credentials of the client device.

E5. The method of example E4, wherein the message identifier is included in the encrypted portion of the session resumption response message, and wherein the session identifier is included in an unencrypted portion of the session resumption response message.
E6. The method of example E3, further comprising:

receiving encrypted data from the server responsive to the session resumption response message.

E7. The method of example E1, wherein the secure communication session comprises a Datagram Transport Layer Security (DTLS) session.
E8. The method of example E1, wherein the client device comprises a Lightweight Machine to Machine (“LwM2M”) client and the server comprises a LwM2M server.
E9. An example device comprising:

a memory;

a processor coupled to the memory, the processor configured to:
establish a secure communication session with a server including performing mutual authentication and determining security credentials; and
receive a session resumption request message from the server after a period of time has elapsed to resume the secure communication session between the device and the server without repeating at least a portion of the mutual authentication between the device and the server, the session resumption request message comprising a session identifier associated with the secure communication session and a message identifier.
   E10. An example device comprising:

means for establishing a secure communication session with a server including performing mutual authentication and determining security credentials; and

means for receiving a session resumption request message from the server after a period of time has elapsed to resume the secure communication session between the device and the server without repeating at least a portion of the mutual authentication between the device and the server, the session resumption request message comprising a session identifier associated with the secure communication session and a message identifier.

E11. A non-transitory, computer-readable medium, having stored thereon computer-readable instructions for managing data communications, comprising instructions configured to cause a computing device to:

establish a secure communication session with a server including performing mutual authentication and determining security credentials; and

receive a session resumption request message from the server after a period of time has elapsed to resume the secure communication session between the computing device and the server without repeating at least a portion of the mutual authentication between the computing device and the server, the session resumption request message comprising a session identifier associated with the secure communication session and a message identifier.

E12. An example method for managing data communications comprising:

establishing, by a server, a secure communication session with a client device including performing mutual authentication and determining security credentials; and

receiving a session resumption request message from the client device, after a period of time has elapsed, to resume the secure communication session between the client device and the server without repeating at least a portion of the mutual authentication between the client device and the server, the session resumption request message comprising a session identifier associated with the secure communication session and a message identifier.

E13. The method of example E12, further comprising:

authenticating the session resumption request message from the client device by
decrypting an encrypted portion of the session resumption request message from the client device using cryptographic keys associated with the security credentials for the client device to generated decrypted content;
extracting a message identifier from the decrypted content; and
determining whether the message identifier is an expected value.
   E14. The method of example 18, further comprising:

sending a session resumption response message to the client device responsive to authenticating the session resumption request message.

E15. The method of example 19, further comprising:

encrypting at least a portion of the session resumption response message using a cryptographic key associated with the security credentials of the server.

E16. The method of example 20, wherein the message identifier is included in the encrypted portion of the session resumption response message, and wherein the session identifier is included in an unencrypted portion of the session resumption response message.
E17. The method of example 19, further comprising:

receiving encrypted data from the client device responsive to the session resumption response message.

E18. The method of example E12, wherein the secure communication session comprises a Datagram Transport Layer Security (DTLS) session.
E19. The method of example E12, wherein the client device comprises a Lightweight Machine to Machine (“LwM2M”) client and the server comprises a LwM2M server.
E20. An example server comprising:

a memory;

a processor coupled to the memory, the processor configured to:
establish a secure communication session with a client device including performing mutual authentication and determining security credentials; and
receiving a session resumption request message from the client device, after a period of time has elapsed, to resume the secure communication session between the client device and the server without repeating at least a portion of the mutual authentication between the client device and the server, the session resumption request message comprising a session identifier associated with the secure communication session and a message identifier.
   E21. An example server comprising:

means for establishing a secure communication session with a client device including performing mutual authentication and determining security credentials; and

means for receiving a session resumption request message from the client device, after a period of time has elapsed, to resume the secure communication session between the client device and the server without repeating at least a portion of the mutual authentication between the client device and the server, the session resumption request message comprising a session identifier associated with the secure communication session and a message identifier.

E22. A non-transitory, computer-readable medium, having stored thereon computer-readable instructions for managing data communications, comprising instructions configured to cause a server to:

establish establishing a secure communication session with a client device including performing mutual authentication and determining security credentials; and

receive a session resumption request message from the client device, after a period of time has elapsed, to resume the secure communication session between the client device and the server without repeating at least a portion of the mutual authentication between the client device and the server, the session resumption request message comprising a session identifier associated with the secure communication session and a message identifier.

E23. A method for managing data communications comprising:

establishing, by a server, a secure communication session with a client device including performing mutual authentication and determining security credentials; and

sending a session resumption request message to the client device after a period of time has elapsed to resume the secure communication session between the client device and the server without repeating at least a portion of the mutual authentication between the client device and the server, the session resumption request message comprising a session identifier associated with the secure communication session and a message identifier.

E24. The method of claim E23, wherein sending the session resumption request further comprises:

encrypting at least a portion of the session resumption request message using a cryptographic key associated with the security credentials of the server.

E25. The method of claim E24, wherein the message identifier is included in the encrypted portion of the session resumption request message, and wherein the session identifier is included in an unencrypted portion of the session resumption request message.
E26. The method of claim E23, further comprising:

receiving a session resumption response from the client device indicating whether the client device has accepted the session resumption request from the server.

E27. The method of claim E26, further comprising:

authenticating the session resumption response message from the client device by
decrypting an encrypted portion of the session resumption request message from the server using cryptographic keys associated with the security credentials for the server to generated decrypted content,
extracting a message identifier from the decrypted content, and
determining whether the message identifier is an expected value.
   E28. The method of claim E27, further comprising:

sending encrypted data to the client device responsive to authenticating the session resumption response message.

E29. The method of claim E23, wherein the secure communication session comprises a Datagram Transport Layer Security (DTLS) session.
E30. The method of claim E23, wherein the client device comprises a Lightweight Machine to Machine (“LwM2M”) client and the server comprises a LwM2M server.
E31. An example server comprising:

a memory;

a processor coupled to the memory, the processor configured to:
establish a secure communication session with a client device including performing mutual authentication and determining security credentials; and
send a session resumption request message to the client device after a period of time has elapsed to resume the secure communication session between the client device and the server without repeating at least a portion of the mutual authentication between the client device and the server, the session resumption request message comprising a session identifier associated with the secure communication session and a message identifier.
   E32. An example server comprising:

means for establishing, by a server, a secure communication session with a client device including performing mutual authentication and determining security credentials; and

means for sending a session resumption request message to the client device after a period of time has elapsed to resume the secure communication session between the client device and the server without repeating at least a portion of the mutual authentication between the client device and the server, the session resumption request message comprising a session identifier associated with the secure communication session and a message identifier.

E33. A non-transitory, computer-readable medium, having stored thereon computer-readable instructions for managing data communications, comprising instructions configured to cause a server to:

establish a secure communication session with a client device including performing mutual authentication and determining security credentials; and

send a session resumption request message to the client device after a period of time has elapsed to resume the secure communication session between the client device and the server without repeating at least a portion of the mutual authentication between the client device and the server, the session resumption request message comprising a session identifier associated with the secure communication session and a message identifier.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media. Tangible media include one or more physical articles of machine readable media, such as random access memory, magnetic storage, optical storage media, and so on.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. Such media also provide examples of non-transitory media, which can be machine readable, and wherein computers are an example of a machine that can read from such non-transitory media.

The generic principles discussed herein may be applied to other implementations without departing from the spirit or scope of the disclosure or claims.

What is claimed is:

1. A method for managing data communications comprising:
establishing, by a client device, a secure communication session with a server including performing mutual authentication and determining security credentials; and
sending a session resumption request message to the server, after a period of time has elapsed since the secure communication session has been established, to resume the secure communication session between the client device and the server without repeating at least a portion of the mutual authentication between the client device and the server, the session resumption request message comprising a session identifier associated with the secure communication session and a message identifier.

2. The method of claim 1, wherein sending the session resumption request message further comprises:
encrypting at least a portion of the session resumption request message using a cryptographic key associated with the security credentials of the client device.

3. The method of claim 2, wherein the message identifier is included in the encrypted portion of the session resumption request message, and wherein the session identifier is included in an unencrypted portion of the session resumption request message.

4. The method of claim 1, further comprising:
receiving a session resumption response message from the server indicating whether the server has accepted the session resumption request message from the server.

5. The method of claim 4, further comprising:
authenticating the session resumption response message from the server by
decrypting an encrypted portion of the session resumption response message from the server using cryptographic keys associated with the security credentials for the server to generate decrypted content,
extracting the message identifier from the decrypted content, and
determining whether the message identifier is an expected value.

6. The method of claim 5, further comprising:
sending encrypted data to the server responsive to authenticating the session resumption response message.

7. The method of claim 1, wherein the secure communication session comprises a Datagram Transport Layer Security (DTLS) session.

8. The method of claim 1, wherein the client device comprises a Lightweight Machine to Machine (“LwM2M”) client and the server comprises a LwM2M server.

9. A device comprising:
a memory;
a processor coupled to the memory, the processor configured to:
establish a secure communication session with a server including performing mutual authentication and determining security credentials; and
send a session resumption request message to the server, after a period of time has elapsed since the secure communication session has been established, to resume the secure communication session between the device and the server without repeating at least a portion of the mutual authentication between the device and the server, the session resumption request message comprising a session identifier associated with the secure communication session and a message identifier.

10. The device of claim 9, wherein the processor being configured to send the session resumption request message is further configured to:
encrypt at least a portion of the session resumption request message using a cryptographic key associated with the security credentials of the device.

11. The device of claim 10, wherein the message identifier is included in the encrypted portion of the session resumption request message, and wherein the session identifier is included in an unencrypted portion of the session resumption request message.

12. The device of claim 9, wherein the processor is further configured to:
receive a session resumption response message from the server indicating whether the server has accepted the session resumption request message from the server.

13. The device of claim 12, wherein the processor is configured to authenticate the session resumption response message from the server, the processor being further configured to:
decrypt an encrypted portion of the session resumption response message from the server using cryptographic keys associated with the security credentials for the server to generate decrypted content,
extract the message identifier from the decrypted content, and
determine whether the message identifier is an expected value.

14. The device of claim 13, wherein the processor is further configured to:
sending encrypted data to the server responsive to authenticating the session resumption response message.

15. The device of claim 9, wherein the secure communication session comprises a Datagram Transport Layer Security (DTLS) session.

16. The device of claim 9, wherein the device comprises a Lightweight Machine to Machine (“LwM2M”) client and the server comprises a LwM2M server.

17. A device comprising:
means for establishing a secure communication session with a server including performing mutual authentication and determining security credentials; and
means for sending a session resumption request message to the server, after a period of time has elapsed since the secure communication session has been established, to resume the secure communication session between the device and the server without repeating at least a portion of the mutual authentication between the device and the server, the session resumption request message comprising a session identifier associated with the secure communication session and a message identifier.

18. The device of claim 17, wherein the means for sending the session resumption request message further comprises:
means for encrypting at least a portion of the session resumption request message using a cryptographic key associated with the security credentials of the device.

19. The device of claim 18, wherein the message identifier is included in the encrypted portion of the session resumption request message, and wherein the session identifier is included in an unencrypted portion of the session resumption request message.

20. The device of claim 17, further comprising:
means for receiving a session resumption response message from the server indicating whether the server has accepted the session resumption request message from the server.

21. The device of claim 20, further comprising:
means for authenticating the session resumption response message from the server comprising
means for decrypting an encrypted portion of the session resumption response message from the server using cryptographic keys associated with the security credentials for the server to generate decrypted content,
means for extracting the message identifier from the decrypted content, and
means for determining whether the message identifier is an expected value.

22. The device of claim 21, further comprising:
means for sending encrypted data to the server responsive to authenticating the session resumption response message.

23. The device of claim 17, wherein the secure communication session comprises a Datagram Transport Layer Security (DTLS) session.

24. The device of claim 17, wherein the device comprises a Lightweight Machine to Machine (“LwM2M”) client and the server comprises a LwM2M server.

25. A non-transitory, computer-readable medium, having stored thereon computer-readable instructions for managing data communications, comprising instructions configured to cause a computing device to:
establish a secure communication session with a server including performing mutual authentication and determining security credentials; and
send a session resumption request message to the server, after a period of time has elapsed since the secure communication session has been established, to resume the secure communication session between the computing device and the server without repeating at least a portion of the mutual authentication between the computing device and the server, the session resumption request message comprising a session identifier associated with the secure communication session and a message identifier.

26. The non-transitory, computer-readable medium of claim 25, wherein the instructions configured to cause the computing device to send the session resumption request message further instructions configured to cause the computing device to:
encrypt at least a portion of the session resumption request message using a cryptographic key associated with the security credentials of the computing device.

27. The non-transitory, computer-readable medium of claim 26, wherein the message identifier is included in the encrypted portion of the session resumption request message, and wherein the session identifier is included in an unencrypted portion of the session resumption request message.

28. The non-transitory, computer-readable medium of claim 25, further comprising instruction configured to cause the computing device to:
receive a session resumption response message from the server indicating whether the server has accepted the session resumption request message from the server.

29. The non-transitory, computer-readable medium of claim 28, further comprising instructions configured to cause the computing device to:
authenticate the session resumption response message from the server, the instructions further comprising instructions configured to cause the computing device to:
decrypt an encrypted portion of the session resumption response message from the server using cryptographic keys associated with the security credentials for the server to generate decrypted content,
extract the message identifier from the decrypted content, and
determine whether the message identifier is an expected value.

30. The non-transitory, computer-readable medium of claim 29, wherein the secure communication session comprises a Datagram Transport Layer Security (DTLS) session, and wherein the computing device comprises a Lightweight Machine to Machine (“LwM2M”) client and the server comprises a LwM2M server.
